(19) United States
(12) Patent Application Publication
(10) Pub. No.: US 2018/0148964 A1
(43) Pub. Date: May 31, 2018

(54) OVERHEAD DOOR CABLE ADJUSTER SYSTEM AND METHOD

(71) Applicant: Raymond Lyle Tipler, Wainwright (CA)

(72) Inventor: Raymond Lyle Tipler, Wainwright (CA)

(21) Appl. No.: 15/365,870

(22) Filed: Nov. 30, 2016

(51) Int. Cl. E05D 13/00

(52) U.S. Cl. CPC E05D 13/1215; E05Y 2900/106

(57) ABSTRACT

The overhead door cable adjuster system includes a tensioning assembly, and a second pulley. The overhead door cable adjuster system is useful for easily installing a garage door cable and adjusting the door height while working on the ground level thus enhancing safety while saving time and expense.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. FIELD OF THE INVENTION

The present invention relates generally to the field of movable or removable enclosures and more specifically relates to garage doors.

### 2. DESCRIPTION OF RELATED ART

Overhead doors are a common type of garage door on many types of buildings. The weight of an overhead door is countered with a spring arrangement whereas the spring is adjusted to a preset tension level. The spring is often located at the top of an overhead door and connected to the bottom of the overhead door via a cable assembly. The combination of a spring under tension along with a cable assembly is used to offset the weight of an overhead door thus making the door easier to lift.

The tension spring of an overhead door is typically adjusted with a combination of removable levers that that are manually inserted into receiving holes. Levers can slip or create a counter force causing the spring's energy to unwind rapidly and risk injuring those in the vicinity. Overhead door springs are not a common item in home improvement stores. The elevated position of an overhead door spring requires installation, adjustment, and service to be performed while on a ladder or scaffolding. Performing work in an elevated position is a safety risk when compared to work that is performed at ground level. Overhead door springs are installed, adjusted, and serviced mostly by professionals, thus added cost and down time are commonly experienced when overhead door springs are installed, adjusted, or serviced. Fine adjustment of overhead door height can require multiple trips to an elevated level of the spring location and further tensioning of the spring thus risking safety even further which is not desirable.

Cable service and replacement requires readjusting the spring tension of an overhead door. Thus cable replacement is often performed by professionals due to safety concerns. Due to the added safety risk as well as the added cost and time delays for a professional installer to replace overhead door springs and/or cables, a suitable solution is required.

U.S. Pat. No. 9,045,928 to Seitz and Hopper relates to a method and apparatus to raise and lower an overhead door. The described method and apparatus to raise and lower an overhead door includes a lift mechanism, a master pulley block, a fixed pulley mounted to the lift mechanism, a plurality of guide sheaves each associated and spaced from with the master pulley block and supported by the elongated support member, and a plurality of cables each having two opposing ends and passing over the fixed pulley and the master pulley block and further passing over an associated one of the plurality of guide sheaves, wherein each cable of the plurality of cables attaches by attachment means to an overhead door.

### BRIEF SUMMARY OF THE INVENTION

In view of the foregoing disadvantages inherent in the known garage doors art, the present disclosure provides a novel overhead door cable adjuster system. The general purpose of the present disclosure, which will be described subsequently in greater detail, is to provide an overhead door cable adjuster system as well as a method by which to adjust tension on a cable assembly as a means for adjusting overhead door and door height while working at ground level.

An overhead door cable adjuster system is disclosed herein for the purpose of easily installing a garage door cable and adjusting the door height while working on ground level. The disclosure provides a further advantage of creating tension on a garage door cable assembly with a simple turn of a wrench thus reducing the need for using levers and working at an elevated level while adjusting a spring. This disclosure offers the advantages of improved safety and time savings.

In the preferred embodiment, the overhead door cable adjuster system includes a tensioning assembly and a second pulley. According to this embodiment, the tensioning assembly has together in functional combination a bracket, a combination first pulley and gear, a first shaft, a combination first pulley and gear retainer, a gear lock, a second shaft, and a lock retainer. The second pulley is mounted to a door assembly axle of a door wheel assembly of the overhead door for the purpose of directing the cable assembly to the tensioning assembly. The tensioning assembly and the second pulley work together in functional combination to provide a method by which to apply tension to an overhead door spring via the cable assembly for the purpose of adjusting the overhead door's height. The tensioning assembly includes a combination first pulley and gear and a gear lock that work together in functional combination for the purpose of tensioning a spring of an overhead door cable assembly with a set amount of tension via a cable assembly based on positioning of the cable assembly within the first pulley of the combination first pulley and gear in relation to the gear lock.

Referring further to the preferred embodiment, the first pulley is preferably of a fixed diameter of three inches and can accommodate a single spool of cable. The gear lock includes a tensioning spring for the purpose of securing the gear lock into the teeth of the gear. The gear teeth comprise a sprocket profile and the lock lobe is of a profile that locks into gear teeth (teeth on the gear) with the sprocket profile. The lock lobe is configured to lock in a unidirectional manner as a means for tightening the cable assembly while turning the combination first pulley and gear without having to disengage the lock lobe from the gear. The unidirectional configuration operates in a manner that allows the lock lobe to slip over the gear teeth (teeth of the gear) when a user is tightening the combination first pulley and gear it locks when the cable assembly and subsequent spring tension attempts to rotate the combination first pulley and gear in the opposite direction. The combination first pulley and gear is removably couplable as the combination first pulley and gear retainer is a snap ring in the preferred embodiment. For the purpose of toolless coupling, the combination first pulley and gear retainer is a cotter pin in an alternate embodiment. The lock ring is a snap ring in preferred embodiments.

According to another embodiment, an overhead door cable adjuster system is also disclosed whereas the combination first pulley and gear is available in a plurality of diameters (sizes). In alternate embodiments, the first pulley can accommodate multiple spools of cable. For this alternate embodiment, the gear teeth comprise a beveled profile and the lock lobe profile accommodates gear teeth with a beveled profile. In alternate embodiments, the lock lobe is configured to lock in a bidirectional manner as a means for tightening the cable assembly while turning the combination first pulley and gear while having to disengage the lock lobe from the gear. In a third embodiment, the first pulley is of a varying diameter as one traverses the circumference in a manner similar to the lobe on a camshaft. A first pulley with a varying diameter would enable variations in the cable tension of a varying amounts rather than a first pulley with a fixed diameter thus enabling more adjusting options for the user in the alternate embodiment.

The overhead door cable adjuster system and method includes the steps of installing the overhead door cable adjuster system, wrapping the cable assembly around the second pulley, inserting the cable assembly into the cable notch, tightening the adjustment nut, and locking the gear lock by rotating lock lobe into the gear. The overhead door cable adjuster system and method further includes the steps of adjusting the height of door, turning, the adjustment nut to achieve a proper height for door, and locking the gear lock by rotating the lock lobe into the gear.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, an overhead door cable adjuster system, constructed and operative according to the teachings of the present disclosure.

FIG. 1 is perspective view of the overhead door cable adjuster system during an ‘in-use’ condition, according to an embodiment of the disclosure.

FIG. 2 is a perspective view of the overhead door cable adjuster system of FIG. 1, according to an embodiment of the present disclosure.

FIG. 3A provides a more detailed perspective view of the overhead door cable adjuster system of FIG. 1, according to an embodiment of the present disclosure.

FIG. 3B provides another detailed perspective view of the overhead door cable adjuster system of FIG. 1, according to an embodiment of the present disclosure.

FIG. 4 is yet another perspective view of the overhead door cable adjuster system of FIG. 1, according to an embodiment of the present disclosure.

FIG. 5 is a flow diagram illustrating a method of use for an overhead door cable adjuster system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to garage doors and more particularly to an overhead door cable adjuster system as used to improve the act of replacing and overhead door cable assembly and properly adjusting the door height. Generally speaking, cable replacement on overhead doors can be performed faster and safer by using the system and method disclosed herein. The disclosure also offers improved ability to adjust overhead door height.

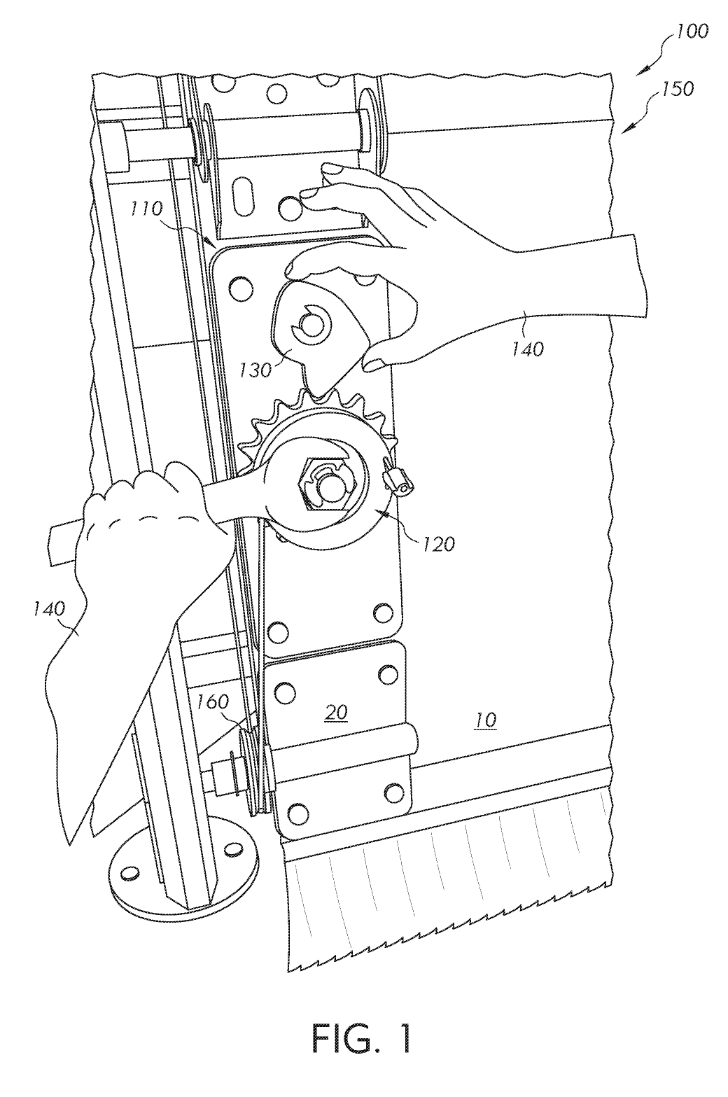

Referring now more specifically to the drawings by numerals of reference, there is shown in FIGS. 1-4, various views of a overhead door cable adjuster system 100.

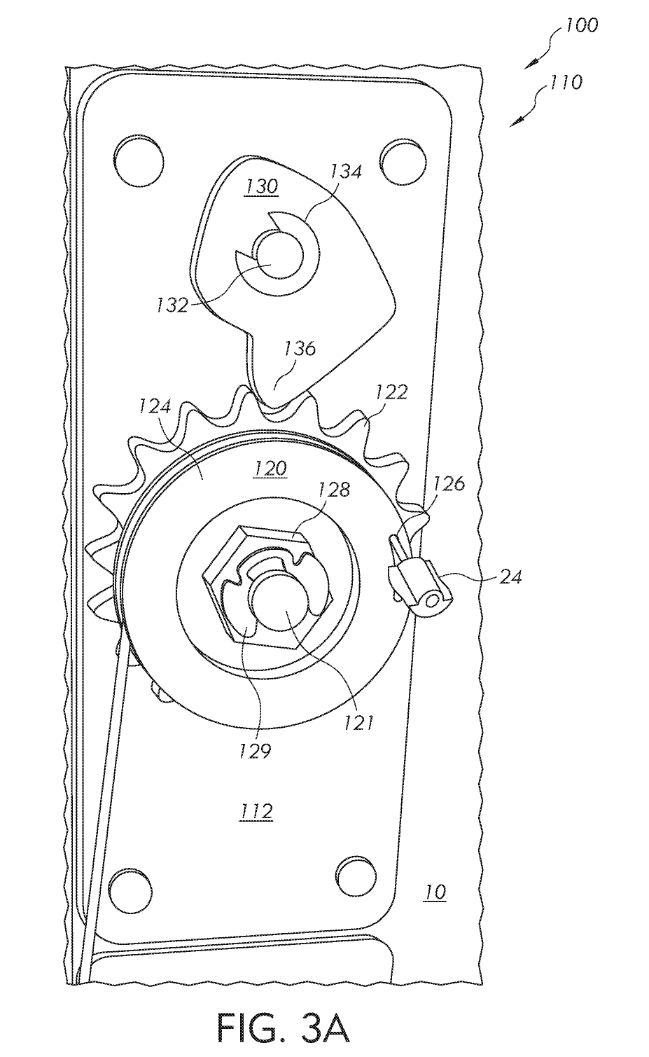

FIG. 1 shows an overhead door cable adjuster system 100 during an ‘in-use’ condition 150, according to an embodiment of the present disclosure. Here, the overhead door cable adjuster system 100 may be beneficial for use by a user 140 to easily replace a cable assembly 24 (FIG. 3a) and adjust the height of an overhead door 10. As illustrated, the overhead door cable adjuster system 100 may include tensioning assembly 110 and second pulley 160. Tensioning assembly 110 includes combination first pulley and gear 120 for user 140 to adjust spring tension via cable assembly 24 in an overhead garage door 10. User 140 is shown grasping gear lock 130 prior to disengaging from the lock position in order to allow combination first pulley and gear 120 to be rotated thereby adjusting the height of an overhead door 10. Upon achieving proper height of door 10 user 140 secures lock 130 into combination first pulley and gear 120. The disclosure enables door 10 adjustment at ground level using simple tools thus avoiding work at an elevated level using levers under spring pressure.

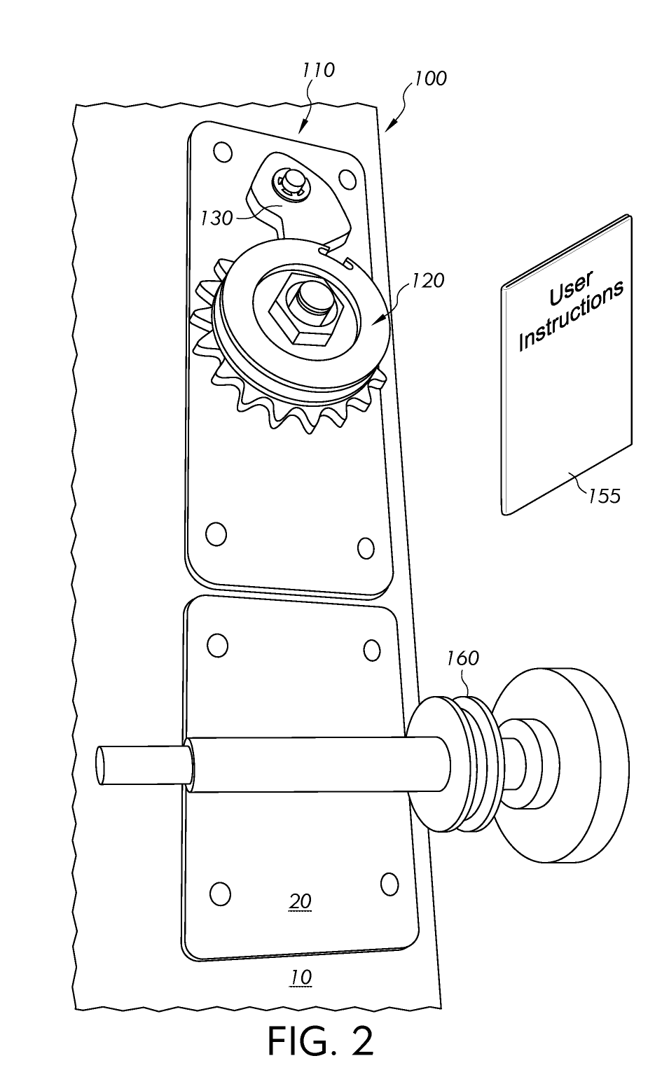

Referring now to FIG. 2 according to one embodiment, the overhead door cable adjuster system 100 may be arranged as a kit 105. In particular, the overhead door cable adjuster system 100 may further include a set of instructions 155 and a plurality of combination first pulley and gear 120 sets with varying diameters (sizes) of first pulley 124. The instructions 155 may detail functional relationships in relation to the structure of the overhead door cable adjuster system 100 (such that the overhead door cable adjuster system 100 can be used, maintained, or the like, in a preferred manner).

Referring further to FIG. 2 a high level perspective view of an overhead door cable adjuster system 100 is shown according to an embodiment of the present disclosure. As illustrated, the overhead door cable adjuster system 100 may include tensioning assembly 110 and second pulley 160 that work together in functional combination for the purpose of adjusting the height of overhead door 10.

FIG. 3A shows a detailed perspective view of an overhead door cable adjuster system 100 according to an embodiment of the present disclosure. As illustrated, the overhead door cable adjuster system 100 may include tensioning assembly 110 having bracket 112, combination first pulley and gear 120, first shaft 121, combination first pulley and gear retainer 129, gear lock 130, second shaft 132, and lock retainer 134. Combination first pulley and gear 120 includes first pulley 124, adjustment nut 128, and gear 122 together in functional combination for the purpose of retaining and applying tension to cable assembly 24. Combination first pulley and gear 120 includes gear 122 affixed to first pulley 120 which in turn is affixed to adjusting nut 128. The combined assembly works together in functional combination whereas the components rotate together as a single unit in a manner that retains and applies tension to cable assembly 24 for the purpose of adjusting the height of door 10. Combination first pulley and gear 120 is removably couplable from first shaft 121 by removing combination first pulley and gear retainer 129. Gear lock 130 is removably couplable from second shaft 132. Profile of gear lock 130 is such that gear lock 130 can be oriented for applications on right or left sides of overhead doors 10 by inverting gear lock 130 on said second shaft 132. Overhead door 10 leveling is enhanced when incorporating two overhead door cable adjuster systems 100, arranged one overhead door cable adjuster system 100 on each side of an overhead door 10 thus enabling individual height adjustment in an effort to level overhead door 10.

Combination first pulley and gear 120 rotates about first shaft 121 when a wrench is used to turn adjusting nut 128. Adjusting nut 128 is fastened to first pulley 120 to provide a means by which to spool cable assembly 24 when the combination first pulley and gear 120 is rotated. Combination first pulley and gear 120 includes first pulley 124 having cable notch 126. Cable assembly 24 rides in a groove in first pulley 124 while being secured by cable notch 126. In the preferred embodiment first pulley 124 accommodates a single spool of cable assembly 24. In alternate embodiments, first pulley 124 is capable of accommodating multiple spools of cable assembly 24. Gear lock 130 includes lock lobe 136 with a profile that fits into gear teeth on gear 122 for the purpose of locking gear 122 in place which in turn secures cable assembly 24 with a set amount of tension for final adjustment of the height of door 10. In the preferred embodiment, gear lock 130 includes a lock lobe 136 configured to lock in a unidirectional manner as a means for tightening cable assembly 24 while turning the combination first pulley and gear 120 without having to disengage the lock lobe 136 from gear 122. In an alternate embodiment, gear lock 130 includes a lock lobe 136 configured to lock in a bidirectional manner as a means for tightening the cable assembly 24 while turning the combination first pulley and the gear 120 while having to disengage the lock lobe 136 from gear 122. Combination first pulley and gear 120 is fastened to first shaft 121 by combination first pulley and gear retainer 129. First shaft 121 is mounted to bracket 112. Referring still to FIG. 3A, gear lock 130 pivots on second shaft 132 and is secured to second shaft 132 with lock retainer 134.

FIG. 3B shows a detailed perspective view of an overhead door cable adjuster system 100 according to an embodiment of the present disclosure. As illustrated, the overhead door cable adjuster system 100 may include bracket 112 which has first shaft opening 114, second shaft opening 116 and a plurality of mounting holes 118. First shaft 121 is rigidly mounted to bracket 112 via first shaft opening 114. Second shaft 132 is rigidly mounted to bracket 112 via second shaft opening 116.

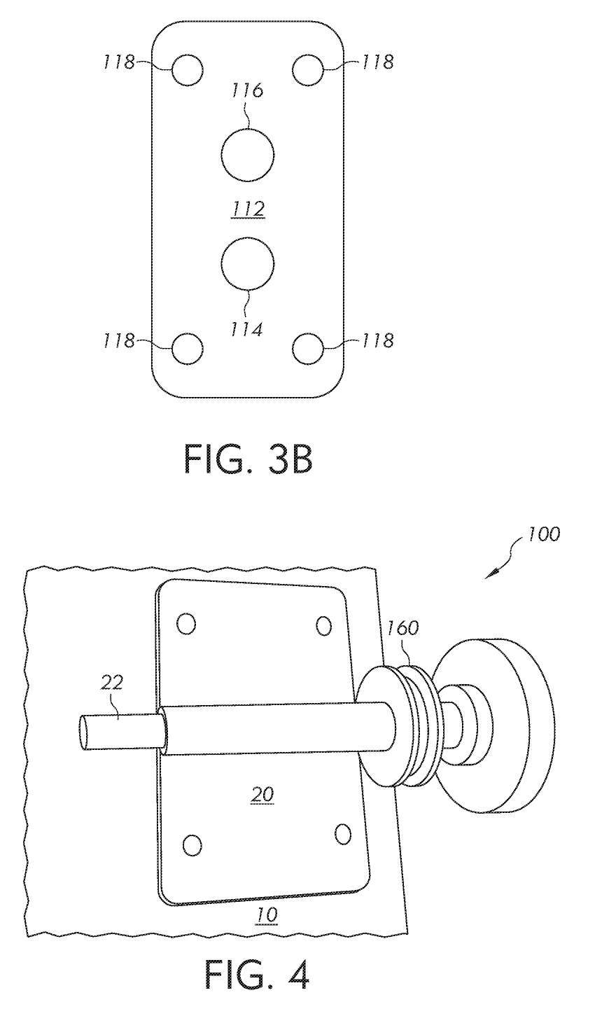

FIG. 4 shows a detailed perspective view of an overhead door cable adjuster system 100 showing second pulley 160 mounted on axle 22 of door wheel assembly 20 that is further mounted to door 10. Second pulley 160 rides on axle 22 as a means for allowing cable assembly 24 to be directed to tensioning assembly 110. FIG. 4 illustrates how the disclosure accommodates existing door hardware while enabling the advantage of ground level adjustment of cable assembly 24 thus providing the advantages of low additional parts count and additional safety and ease of control for user 140.

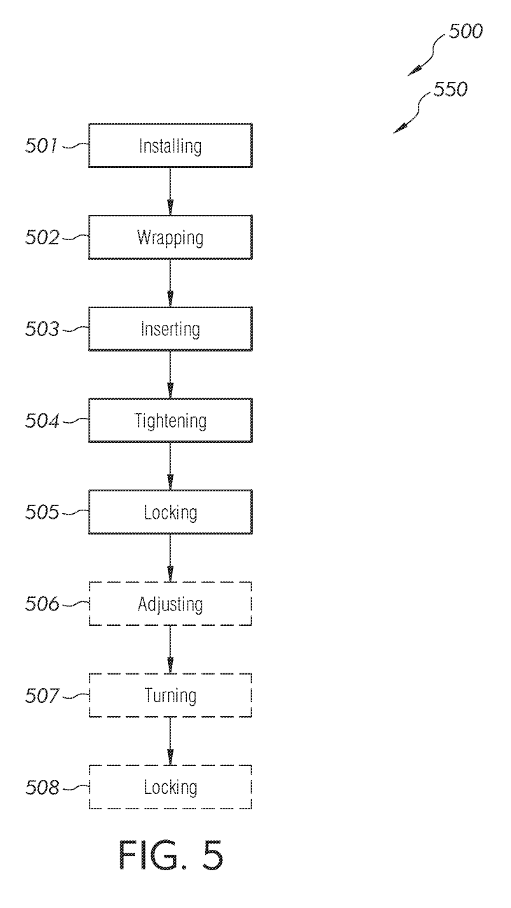

FIG. 5 is a flow diagram 550 illustrating a method of use 500 for an overhead door cable adjuster system 100 according to an embodiment of the present disclosure. Method of use 500 may include one or more components or features of the overhead door cable adjuster system 100 as described above. As illustrated, the method of use 500 for an overhead door cable adjuster 100 includes the steps of: step one 501, installing an overhead door cable adjuster system 100; step two 502, wrapping the cable assembly 24 around the second pulley 160; step three 503, inserting cable assembly 24 in cable notch 126; step four 504, tightening the adjustment nut 128; and step five 505, locking gear lock 130 by rotating lock lobe 136 into gear 122.

The method of use 500 for an overhead door cable adjuster system 100 may further include the steps of: step six 506, adjusting the height of door 10; step seven 507, turning the adjustment nut 128 to achieve a proper height for door 10, and step eight 508, locking the gear lock 130 by rotating lock lobe 136 into gear 122.

It should be noted that steps 506, 507, and 508 are optional steps and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods of use or installation for overhead door cable adjuster system (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An overhead door cable adjuster system comprising:
a tensioning assembly including;
a bracket having;
a first shaft opening;
a second shaft opening; and
a plurality of mounting holes;
a combination first pulley and gear including;
a gear having;
teeth along an outer diametric edge;
a first pulley having;
a cable notch; and
an adjustment nut;
a combination first pulley and gear retainer;
a first shaft;
a gear lock having;
a lock lobe;
a second shaft;
a lock retainer; and
a second pulley;
wherein the tensioning assembly has together in functional combination said bracket, said combination first pulley and gear, said first shaft, said combination first pulley and gear retainer, said gear lock, said second shaft, and said lock retainer for the purpose of retaining an overhead door cable assembly with a set amount of tension based on positioning of said combination first pulley and gear in relation to said gear lock;
wherein said second pulley is mounted to a door assembly axle of a door wheel assembly of said overhead door for the purpose of directing said cable assembly to said tensioning assembly;
wherein said first pulley accommodates a single spool of cable;
wherein said gear lock is removably couplable;
wherein said gear lock profile is such that said gear lock can be oriented for applications on right or left sides of overhead doors by inverting said gear lock on said second shaft; and
wherein said tensioning assembly and said second pulley work together in functional combination to provide a method by which to apply tension to an overhead door spring via said cable assembly for adjusting said overhead door's height.

2. The overhead door cable adjuster system of claim 1, wherein said first pulley is of a fixed diameter.

3. The overhead door cable adjuster system of claim 2, wherein said combination first pulley and gear is removably couplable.

4. The overhead door cable adjuster system of claim 2, wherein said combination first pulley and gear is available in a plurality of diameters of said first pulley.

5. The overhead door cable adjuster system of claim 1, wherein said first pulley is able to accommodate multiple spools of cable.

6. The overhead door cable adjuster system of claim 1, wherein said gear lock includes a tensioning spring for securing said gear lock into said teeth of said gear.

7. The overhead door cable adjuster system of claim 1, wherein said teeth of said gear comprise a sprocket profile.

8. The overhead door cable adjuster system of claim 1, wherein said lock lobe comprises a sprocket profile to accommodate said teeth of said gear comprising a sprocket profile for securing said gear in a manner that keeps said gear from rotating.

9. The overhead door cable adjuster system of claim 8, wherein said teeth of said gear comprise a beveled profile.

10. The overhead door cable adjuster system of claim 9, wherein said lock lobe comprises a beveled gear profile to accommodate said teeth of said gear comprising a beveled gear profile for securing said gear in a manner that keeps said gear from rotating.

11. The overhead door cable adjuster system of claim 1, wherein said lock lobe is configured to lock in a bidirectional manner as a means for tightening the cable assembly while turning the combination first pulley and the gear while having to disengage the lock lobe from the gear.

12. The overhead door cable adjuster system of claim 1, wherein said lock lobe is configured to lock in a unidirectional manner as a means for tightening the cable assembly while turning the combination first pulley and the gear without having to disengage the lock lobe from the gear.

13. The overhead door cable adjuster system of claim 1, wherein said combination first pulley and gear retainer is a snap ring.

14. The overhead door cable adjuster system of claim 1, wherein said combination first pulley and the gear retainer is a cotter pin.

15. The overhead door cable adjuster system of claim 1, wherein said lock ring is a snap ring.

16. The overhead door cable adjuster system of claim 1, wherein said first pulley is of a varying diameter as one traverses an outer diametric of said first pulley.

17. An overhead door cable adjuster system comprising:
a tensioning assembly including;
a bracket having;
a first shaft opening;
a second shaft opening; and
a plurality of mounting holes;
a combination first pulley and gear including;
a gear having;
teeth along an outer diametric edge;
a first pulley having;
a cable notch; and
an adjustment nut;
a combination first pulley and gear retainer;
a first shaft;
a gear lock having;
a lock lobe;
a second shaft;
a lock retainer; and
a second pulley.
wherein the tensioning assembly has together in functional combination said bracket, said combination first pulley and gear, said first shaft, said combination first pulley and gear retainer, said gear lock, said second shaft, and said lock retainer for the purpose of retaining an overhead door cable assembly with a set amount of tension based on the positioning of said first pulley and gear in relation to said gear lock;
wherein said second pulley is mounted to a door assembly axle of a door wheel assembly of said overhead door for the purpose of directing said cable assembly to said tensioning assembly;
wherein said first pulley accommodates a single spool of cable;
wherein said gear lock is removably couplable;
wherein said gear lock profile is such that said gear lock can be oriented for applications on right or left sides of overhead doors by inverting said gear lock on said second shaft’
wherein said tensioning assembly and said second pulley work together in functional combination to provide a means by which to apply tension to a spring of an overhead door via said cable assembly for adjusting height of said overhead door;
wherein said first pulley is of a fixed diameter;
wherein said combination first pulley and said gear is removably couplable;
wherein said gear lock includes a tensioning spring for the purpose of securing said gear lock into the teeth of said gear;
wherein said teeth of said gear comprise a sprocket profile;
wherein said lock lobe comprises a sprocket profile to accommodate said teeth of said gear comprising a sprocket profile for the purpose of securing said gear in a manner that keeps said gear from rotating;
wherein said lock lobe is configured to lock in a unidirectional manner as a means for tightening the cable assembly while turning the combination first pulley and gear without having to disengage the lock lobe from the gear;
wherein said combination first pulley and gear retainer is a snap ring; and
wherein said lock ring is a snap ring.

18. The overhead door cable adjuster system of claim 17, further comprising set of instructions; a tensioning assembly; and a second pulley;
wherein said overhead door cable adjuster system is arranged as a kit with a plurality of said combination first pulley and gear sets each having said first pulley with a unique fixed circumference and fixed outer diameter; and
wherein said overhead door cable adjuster system is arranged as a kit with a plurality of said combination first pulley and gear sets each having said first pulley with a unique varying circumference and varying outer diameter.

19. A method of use of an overhead door cable adjuster system; said overhead door cable adjuster system comprising a second pulley, a first pulley including a cable notch, a tightening nut, and a gear lock including a lock lobe; the method comprising the steps of:
installing said overhead door cable adjuster system;
wrapping said cable assembly around said second pulley;
inserting said cable assembly into said cable notch;
tightening said adjustment nut; and
locking said gear lock by rotating lock lobe into gear.

20. The method of claim 19, further comprising the steps of
adjusting height of said overhead door;
turning said adjustment nut to achieve a proper height for said overhead door; and
locking said gear lock by rotating a lock lobe into gear.
